(19) United States
(12) Patent Application Publication
(10) Pub. No.: US 2008/0102708 A1
(43) Pub. Date: May 1, 2008

(54) KVM SWITCH

(75) Inventor: Hung-June Wu, Pao-chiao City (TW)

Correspondence Address: JUNE-ON CO., LTD., P.O. BOX 108-00403, TAIPEI 106, omitted

(73) Assignee: JUNE-ON CO., LTD., Pao-chiao City (TW)

(21) Appl. No.: 11/554,596

(22) Filed: Oct. 31, 2006

(51) Int. Cl. H01R 25/00

(52) U.S. Cl. 439/652

(57) ABSTRACT

A KVM switch is disclosed to include a housing, VGA ports arranged in pair on front and back panels of the housing for selectively installation of PCs in the front or back side of the housing, switching keys and indicator lights mounted on the front panel of the housing corresponding to the pairs of VGA ports, and a control unit mounted inside the housing to automatically scan connection of KVM cables to the VGA ports and to automatically switch off the corresponding VGA port on the front (or back) side of the housing when one VGA port on the back (or front) side of the housing is connected with the KVM cable.

### BACKGROUND OF THE INVENTION

1. Field of the Invention

The present invention relates to a KVM switch for controlling multiple PCs from one keyboard, mouse and VGA monitor and more particularly, to such a KVM switch, which has VGA ports arranged in pair on the front and back panels of the housing for installation of PCs from the front or back side and a control unit that automatically scans the VGA ports and automatically switches off the corresponding VGA port on the front (or back) side of the housing when one VGA port on the back (or front) side of the housing is connected with a KVM cable.

2. Description of the Related Art

When a computer cannot satisfy the need in working, a new computer may be used. When a new computer is used to substitute for an old computer that is still workable, the old computer may be given up. However, since the invention of KVM switch, it allows a user to control multiple computers from one keyboard, mouse and VGA monitor. KVM is an switch for Keyboard, Video and Mouse. When multiple computers are connected to a KVM switch, these computers can be controlled at any given time. When a user connects a VGA monitor, keyboard and mouse to a KVM switch, then uses KVM cables to connect the KVM switch to the computers. Control is switched from one computer to another by the use of switching keys on the KVM switch.

FIG. 3 illustrates a KVM switch according to the prior art. According to this design, the KVM switch A comprises a housing A1, multiple VGA (Video Graphics Array) ports A21 on the back panel A2 of the housing A1, and multiple switching keys A31 and associating indicator lights A32 on the front panel A3 of the housing A1. When in use, multiple PCs (not shown) are respectively connected to the VGA ports A21 by a respective KVM cable A4. Thus, the user can control these PCs from one keyboard, mouse and VGA monitor (not shown) by means of selectively switching on/off the switching keys A31, and at the same time the associating indicator lights A32 are turned on or off.

According to the foresaid design, the VGA ports A21 are arranged on the back panel A2 of the housing A1. The user may encounter an installation problem when connecting the KVM cables A4 to the KVM switch A in some circumstances, for example, narrow installation space.

Therefore, it is desirable to provide a KVM switch that eliminates the aforesaid problem.

### SUMMARY OF THE INVENTION

The present invention has been accomplished under the circumstances in view. It is therefore one object of the present invention to provide a KVM switch, which has VGA ports on the front side as well as the back side for allowing installation of PCs from the front side or the back side. It is another object of the present invention to provide a KVM switch, which automatically switches off the corresponding VGA port on the front (or back) side when one VGA port on the back (or front) side is connected with a KVM cable.

To achieve these and other objects of the present invention, the KVM switch comprises a housing, multiple VGA ports arranged in pair on front and back panels of the housing for selectively installation of PCs in the front or back side of the housing, switching keys and indicator lights mounted on the front panel of the housing corresponding to the pairs of VGA ports, and a control unit mounted inside the housing to automatically scan connection of KVM cables to the VGA ports. The control unit automatically switches off the corresponding VGA port on the front (or back) side of the housing when one VGA port on the back (or front) side of the housing is connected with a KVM cable.

### BRIEF DESCRIPTION OF THE DRAWINGS

FIG. 1 illustrates the outer appearance of a KVM switch in accordance with the present invention.

FIG. 2 is a system block diagram of the KVM switch according to the present invention.

FIG. 3 illustrates the outer appearance of a KVM switch according to the prior art.

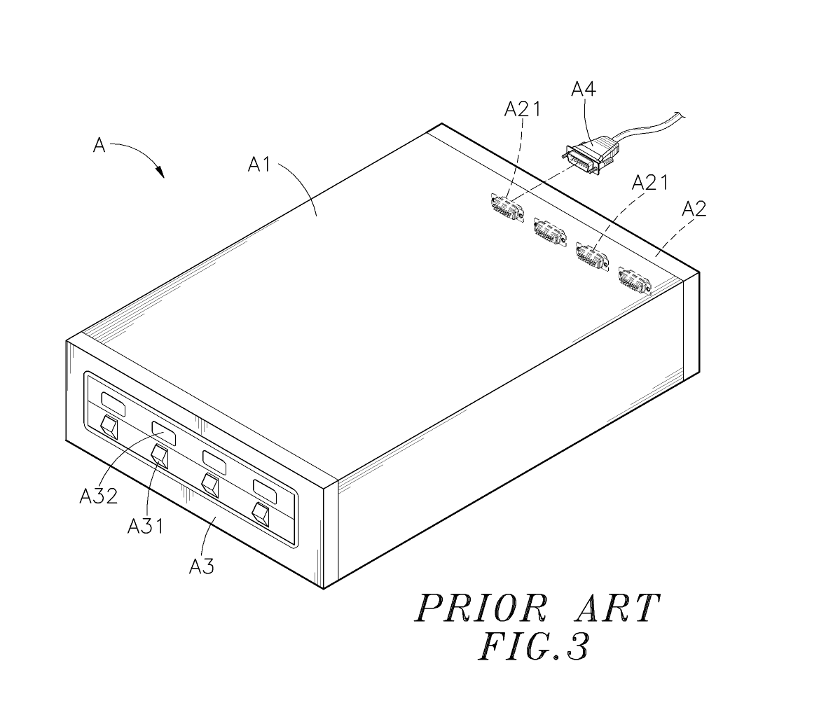

### DETAILED DESCRIPTION OF THE INVENTION

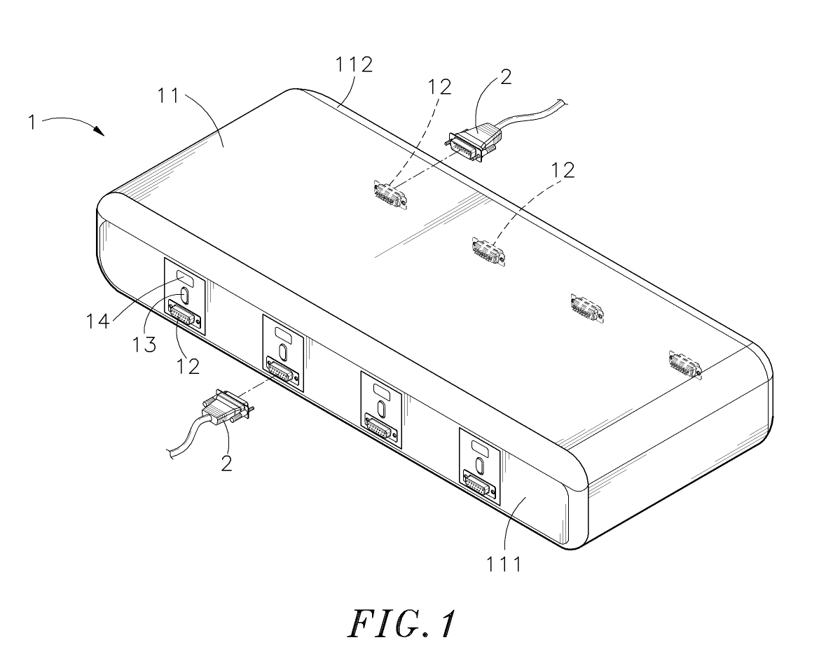

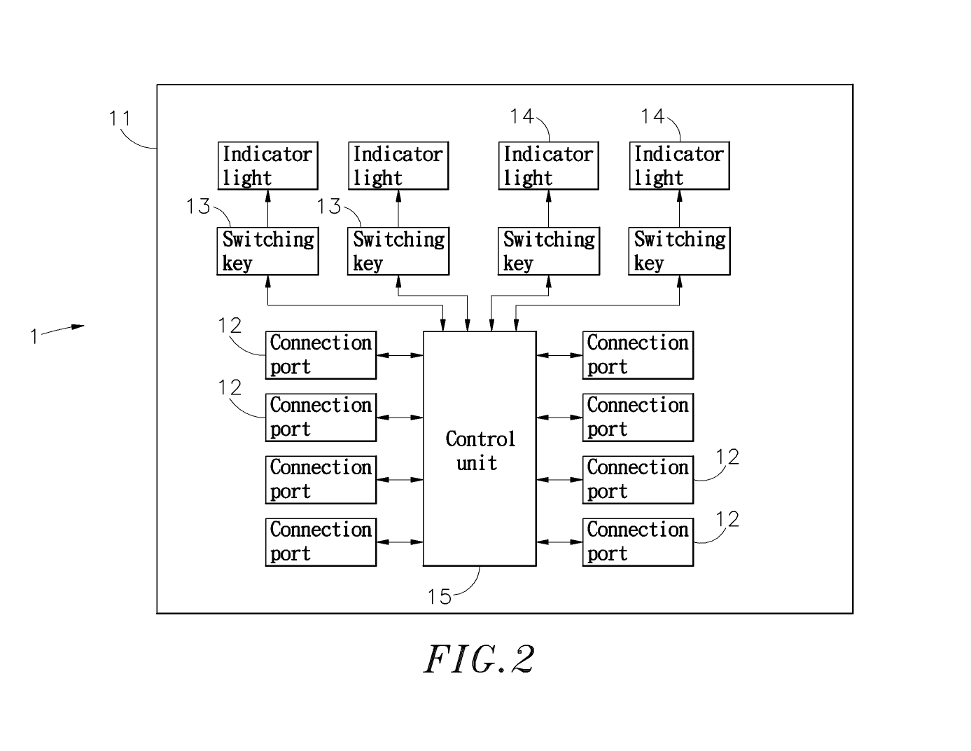

Referring to FIGS. 1 and 2, a VGA switch 1 in accordance with a first embodiment of the present invention is shown comprising a housing 11, multiple connection ports 12, multiple switching keys 13, multiple indicator lights 14, and a control unit 15.

The housing 11 is a hollow shell having a front panel 111 and a back panel 112 opposite to the front panel 111. The connection ports 12 can be VGA (Video Graphics Array) ports, DVI (Digital Visual Interface) ports or other suitable computer connection ports. According to the present invention the connection ports 12 are VGA (Video Graphics Array) ports symmetrically mounted on the front panel 111 and back panel 112 of the housing 11. The switching keys 13 are mounted on the front panel 111 of the housing 11 corresponding to the connection ports 12 on the back panel 112. The indicator lights 14 are mounted on the front panel 111 of the housing 11 corresponding to the switching keys 13 on the front panel 111 of the housing 11. The control unit 15 is mounted inside the housing 11 and electrically connected to the connection ports 12, the switching keys 13 and the indicator lights 14 (see FIG. 2) for operation control and auto scan.

When in use, connection cables, for example, KVM cables 2 are used to connect PCs (Personal Computers) to the connection ports 12 on the front panel 111 and/or the back panel 112 of the housing 11. Thus, the user can control the linked PCs from one keyboard, mouse and VGA monitor (not shown) by means of selectively switching on/off the switching keys 13 and the associating indicator lights 14.

When one KVM cable 2 is connected to one connection port 12 on the front panel 111 of the housing 11, the control unit 15 automatically scans the connection and automatically switches off the corresponding connection port 12 on the back panel 112 of the housing 11. On the contrary, when one KVM cable 2 is connected to one connection port 12 on the back panel 112 of the housing 11, the control unit 15 automatically scans the connection and automatically switches off the corresponding connection port 12 on the front panel 111 of the housing 11. In other words, the connection ports 12 are arranged in pairs on the front panel 111 and back panel 112 of the housing 11. When one connection port 12 is scanned having been connected with a KVM cable 2, the control unit 15 immediately switches off the other connection port 12 of the same pair.

As indicated above, the invention provides a KVM switch, which has the following benefits:

1. The KVM switch 1 has connection ports 12 on the front panel 111 of the housing 11 as well as the back panel 112 of the housing 11 for the connection of KVM cables 2 for selective installation of KVM cables in the front or back side of the housing 11.

2. The control unit 15 of the KVM switch 1 automatically scans the status of the connection ports 12 on the front panel 111 and back panel 112 of the housing 11, and automatically switches off each connection port that is not inserted with a KVM cable.

A prototype of VGA switch has been constructed with the features of FIGS. 1 and 2. The VGA switch functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A KVM switch comprising:
a housing, said housing having a front panel and a back panel opposite to said front panel,
a plurality of computer connection ports mounted on said back panel for receiving cables from computers,
a plurality of switching keys mounted on said front panel for switching On/Off of said computer connection ports, and
a plurality of indicator lights mounted on said front panel corresponding to said switching keys;
wherein a plurality of supplementary connection ports are mounted on said front panel corresponding to said computer connection ports, and a control unit is mounted inside said housing and electrically connected to said computer connection ports, said supplementary connection ports, said switching keys and said indicator lights and adapted to scan connection of a computer cable to each of said computer connection ports and said supplementary connection ports and to switch off said corresponding supplementary connection port when one computer connection port is connected with said computer cable and to switch off said corresponding computer connection port when one supplementary connection port is connected with said computer cable.

2. The KVM switch as claimed in claim 1, wherein said computer connection ports and said supplementary connection ports are VGA (Video Graphics Array) ports.
